(19) United States
(12) Patent Application Publication
(10) Pub. No.: US 2015/0032517 A1
(43) Pub. Date: Jan. 29, 2015

(54) Method for Playing Back Advertisement and Video Content and Electronic Apparatus Using the Method

(71) Applicant: Shanghai PowerMo Information Tech. Co. Ltd., Shanghai (CN)

(72) Inventor: Qi Pan, Shanghai (CN)

(73) Assignee: Shanghai PowerMo Information Tech. Co. Ltd., Shanghai (CN)

(21) Appl. No.: 14/088,477

(22) Filed: Nov. 25, 2013

(30) Foreign Application Priority Data
Jul. 29, 2013 (CN) 201310322342.0

(51) Int. Cl. G06Q 30/02

(52) U.S. Cl. CPC G06Q 30/0241
USPC 705/14.4

(57) ABSTRACT

A method for playing back advertisement and video content and an electronic apparatus using this method are provided, which allows an electronic apparatus to simultaneously play back advertisement and video content. Therefore, a user no need to waste time on waiting until the advertisement is finished. The method includes the following steps: detecting whether an advertisement need to be played back or not; when detecting that the advertisement needs to be played back, splitting an available presenting window of the electronic apparatus into a primary presenting part and at least one secondary presenting part according to a split policy; presenting a video content on the primary presenting part of the available presenting window; and presenting the advertisement on the at least one secondary presenting part of the available presenting window; wherein the video content and the advertisement are presented on the available presenting window of the electronic apparatus simultaneously.

### FIELD OF THE INVENTION

The present invention provides a method for playing back advertisement and video content, and more particularly, to an electronic apparatus that split an available presenting window into a primary presenting part for presenting the video content and at least one secondary presenting part for presenting the advertisement in order to allow the advertisement and the video content to be presented on the same available presenting window simultaneously, such that a user no need to waste time on waiting until the advertisement is finished. The present invention also provides an electronic apparatus using this method, such as a mobile phone, a tablet PC, or a PC.

### BACKGROUND OF THE INVENTION

Recent years, mobile devices become more and more popular and are equipped with more and more functions and thus more requirements for video control, information sharing, and user interactivity are increasing. Furthermore, an advertisement is widely used in website video streaming. Usually, one advertisement is presented before a real video content is presented on the screen, and another advertisement is presented after the video content is finished. However, during the period the advertisement is presented on the screen, it occupies the whole available presenting window and a user needs to wait until the advertisement is finished to start watching the real video content he/she is interested. Or when the video content is paused, the advertisement is presented in front of the video content. Such kind of advertisement presenting method is disruptive and very annoying to the user, and needs to be improved.

Hence, how to provide a better advertisement presenting method allowing the user to watch the real video content that he/she is interested immediately and allowing an electronic apparatus to simultaneously present the advertisement and the video content on the same available presenting window to bring more convenience to the user, has become an important topic in this field.

### SUMMARY OF THE INVENTION

It is one of the objectives of the present invention to provide a method for playing back advertisement and video content and an electronic apparatus using this method, which allows an electronic apparatus to simultaneously present advertisement and video content on the same available presenting window. Therefore, a user no need to waste time on waiting until the advertisement is finished and can start watching the video content he/she is interested so as to solve the problems raised in the prior art.

According to one aspect of the present invention, a method for playing back advertisement and video content is provided. The method includes the following steps: detecting whether an advertisement need to be played back or not; when detecting that the advertisement needs to be played back, splitting an available presenting window of the electronic apparatus into a primary presenting part and at least one secondary presenting part according to a split policy; presenting a video content on the primary presenting part of the available presenting window; and presenting the advertisement on the at least one secondary presenting part of the available presenting window; wherein the video content and the advertisement are presented on the available presenting window of the electronic apparatus simultaneously.

By adopting the method for playing back advertisement and video content and the electronic apparatus using this method of the present invention, a user no need to waste time on waiting until the advertisement is finished and can start watching the video content he/she is interested, which can bring more convenience to the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 (including sub-diagrams FIG. 1A, FIG. 1B, and FIG. 1C) is a diagram showing a conventional electronic apparatus for playing back advertisement and video content according to prior art.

FIG. 2 is a diagram showing an electronic apparatus for playing back advertisement and video content according to an embodiment of the present invention.

FIG. 3 (including sub-diagrams FIG. 3A˜FIG. 3I) is a diagram showing an electronic apparatus for playing back advertisement and video content according to another embodiment of the present invention.

FIG. 4 (including sub-diagrams FIG. 4A, FIG. 4B, and FIG. 4C) is a diagram showing an electronic apparatus for playing back advertisement and video content according to still another embodiment of the present invention.

FIG. 5 is a flowchart illustrating a method for playing back advertisement and video content according to an exemplary embodiment of the present invention.

FIG. 6 is a flowchart illustrating a method for playing back advertisement and video content according to another exemplary embodiment of the present invention.

### DETAILED DESCRIPTION OF PREFERRED EMBODIMENTS

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

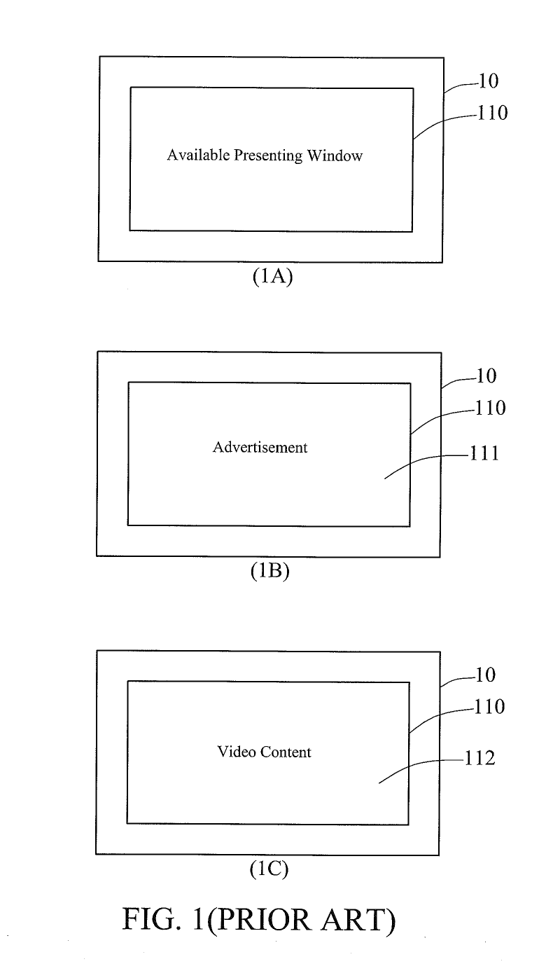

Please refer to FIG. 1. FIG. 1 (including sub-diagrams FIG. 1A, FIG. 1B, and FIG. 1C) is a diagram showing a conventional electronic apparatus for playing back advertisement and video content according to prior art. As shown in FIG. 1A, an electronic apparatus 10 includes an available presenting window 110. Be noted that the position and the size of the available presenting window 110 presented on a display panel of the electronic apparatus 10 are shown in FIG. 1A. According to the prior art, usually an advertisement 111 is presented before the real video content is played back, wherein the advertisement 111 always occupies the whole available presenting window 110 or part of the available presenting window 110, as is shown in FIG. 1B. That is to say, a user needs to wait until the advertisement 111 is finished and can start watching a video content 112 he/she is interested. At this time, the video content 112 will occupy the whole available presenting window 110, as is shown in FIG. 1C. Or when the video content is paused, the advertisement is presented in front of the video content. Such kind of advertisement presenting method is a disruptive and annoying presenting method for the user.

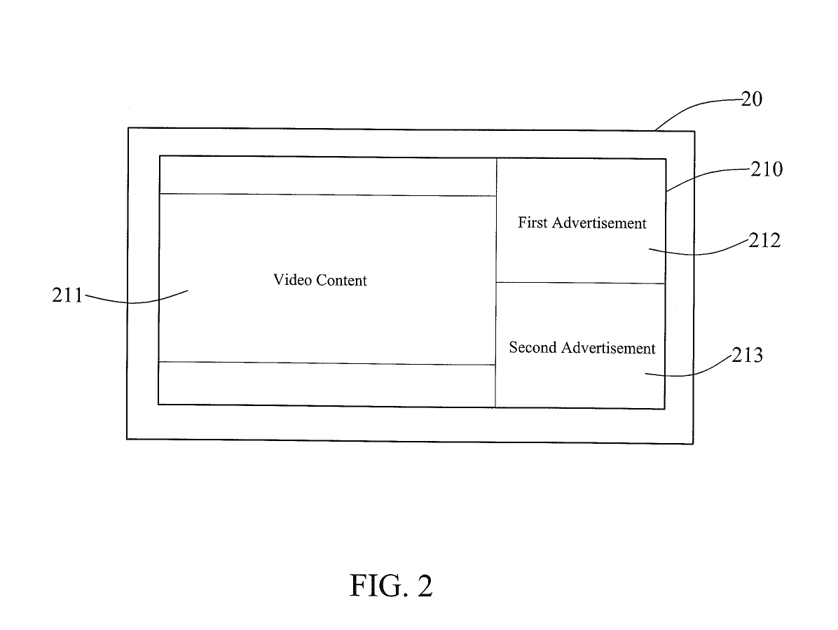

Please refer to FIG. 2. FIG. 2 is a diagram showing an electronic apparatus for playing back advertisement and video content according to an embodiment of the present invention. As shown in FIG. 2, an available presenting window 210 of an electronic apparatus 20 is split into a primary presenting part 211 and at least one secondary presenting parts 212 and 213, wherein a video content is presented on the primary presenting part 211 of the available presenting window 210, a first advertisement is presented on the secondary presenting part 212, and a second advertisement is presented on another secondary presenting part 213, respectively. Therefore, the video content, the first advertisement, and the second advertisement can be simultaneously presented on the available presenting window 210 of the electronic apparatus 20. A user no need to waste time on waiting until the advertisement is finished and can start watching the video content he/she is interested, which can bring more convenience to the user.

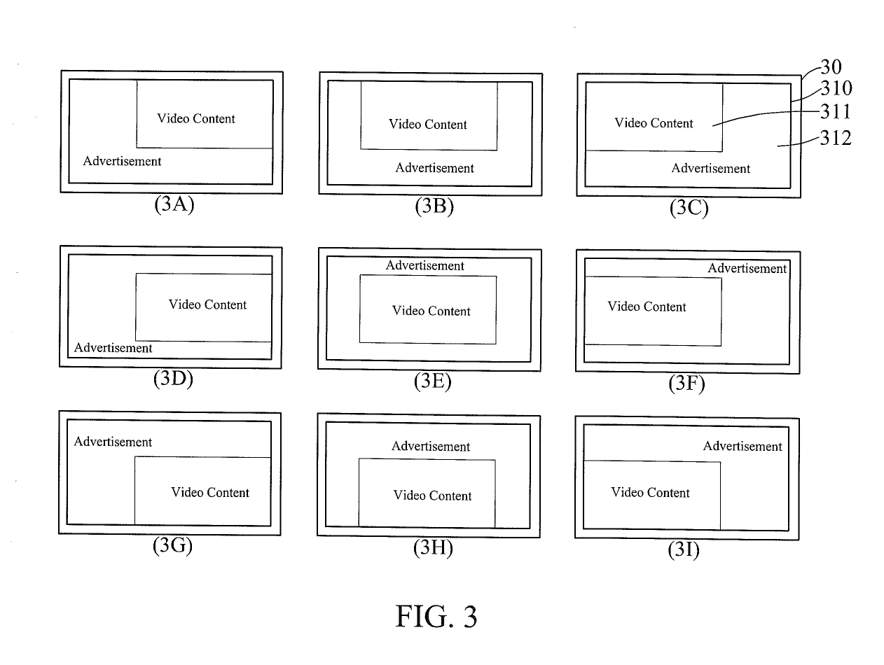

Please refer to FIG. 3. FIG. 3 (including sub-diagrams FIG. 3A˜FIG. 3I) is a diagram showing an electronic apparatus for playing back advertisement and video content according to another embodiment of the present invention. As shown in FIG. 3, an available presenting window 310 of an electronic apparatus 30 is split into a primary presenting part 311 and at least one secondary presenting part 312, wherein a video content is presented on the primary presenting part 311 of the available presenting window 310, and an advertisement is presented on the secondary presenting part 312. Please note that, the size and the location of the primary presenting part 311 (which is used for presenting the video content) are not limitations of the present invention. For example, the primary presenting part 311 can be located on the right-top of the available presenting window 310 (as is shown in FIG. 3A); or the primary presenting part 311 can be located on the left-top of the available presenting window 310 (as is shown in FIG. 3C); or the primary presenting part 311 can be located on the central of the available presenting window 310 (as is shown is FIG. 3E); or the primary presenting part 311 can be located on the left-bottom of the available presenting window 310 (as is shown in FIG. 3I); and the surplus of the available presenting window 310 (i.e., the secondary presenting part 312) is used for presenting the advertisement.

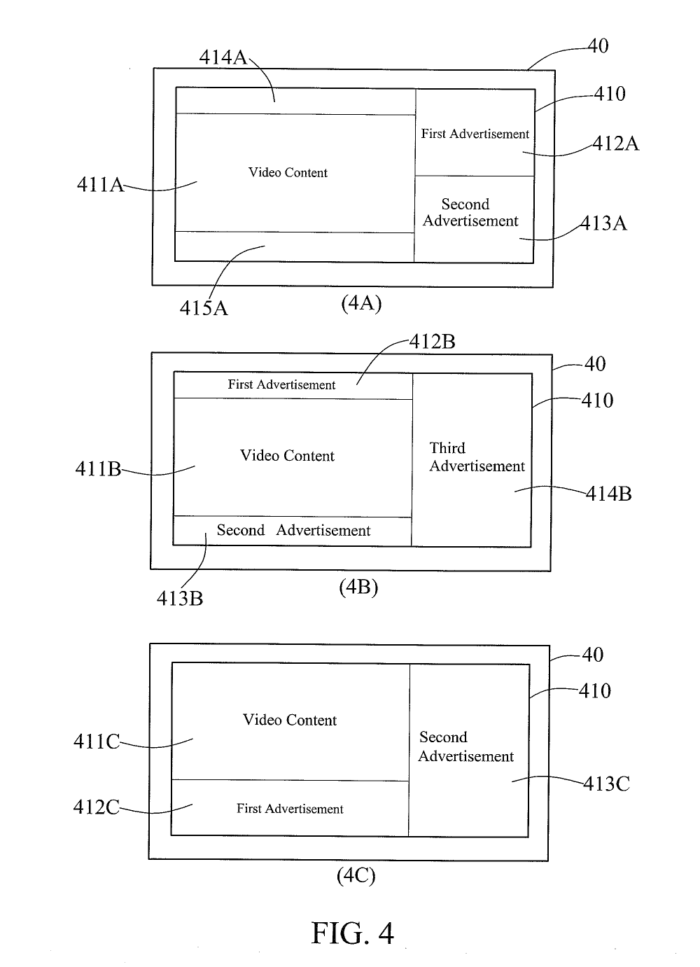

Please refer to FIG. 4. FIG. 4 (including sub-diagrams FIG. 4A, FIG. 4B, and FIG. 4C) is a diagram showing an electronic apparatus for playing back advertisement and video content according to still another embodiment of the present invention. Please note that, in this embodiment, the size, the number, and the location of the secondary presenting part (which is used for presenting advertisement(s)) are not limitations of the present invention. For example, in FIG. 4A, an available presenting window 410 of an electronic apparatus 40 is split into a primary presenting part 411 A and at least one secondary presenting parts 412A and 413A, wherein a video content is presented on the primary presenting part 411A of the available presenting window 410, a first advertisement is presented on the secondary presenting part 412A, a second advertisement is presented on the secondary presenting part 413A, and the surplus parts 414A and 415A are not used. In FIG. 4B, an available presenting window 410 of an electronic apparatus 40 is split into a primary presenting part 411B and at least one secondary presenting parts 412B, 413B, 414B, wherein a video content is presented on the primary presenting part 411B of the available presenting window 410 (the display size and the location of the primary presenting part 411 B shown in FIG. 4B are totally the same as the display size and the location of the primary presenting part 411A shown in FIG. 4A), a first advertisement, a second advertisement, and a third advertisement are respectively presented on the secondary presenting parts 412B, 413B, 414B, and there is no surplus part. In FIG. 4C, an available presenting window 410 of an electronic apparatus 40 is split into a primary presenting part 411C and at least one secondary presenting parts 412C and 413C, wherein a video content is presented on the primary presenting part 411C of the available presenting window 410, a first advertisement and a second advertisement are respectively presented on the secondary presenting parts 412C and 413C, and there is no surplus part.

Please note that, in one embodiment, a sum of the size of the primary presenting part and the size of the second presenting part is smaller than a size of the available presenting window (as is shown in FIG. 4A); and in another embodiment, the sum of the size of the primary presenting part and the size of the second presenting part is equal to the size of the available presenting window (as is shown in FIG. 4B and FIG. 4C).

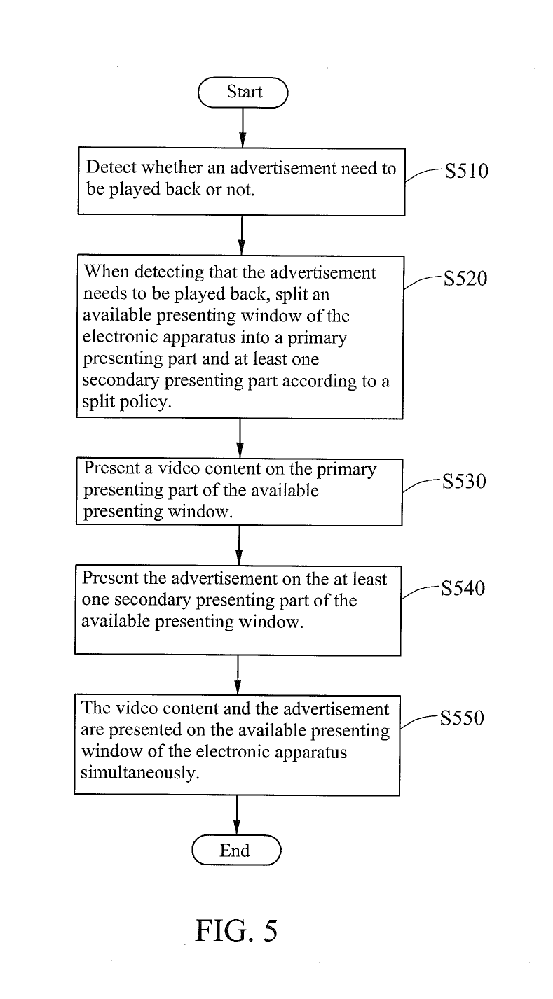

Please refer to FIG. 5. FIG. 5 is a flowchart illustrating a method for playing back advertisement and video content according to an exemplary embodiment of the present invention. As shown in FIG. 5, the method includes, but is not limited to, the following steps:

Step S510: Detect whether an advertisement need to be played back or not.

Step S520: When detecting that the advertisement needs to be played back, split an available presenting window of the electronic apparatus into a primary presenting part and at least one secondary presenting part according to a split policy.

Step S530: Present a video content on the primary presenting part of the available presenting window.

Step S540: Present the advertisement on the at least one secondary presenting part of the available presenting window.

Step S550: The video content and the advertisement are presented on the available presenting window of the electronic apparatus simultaneously.

Those skilled in the art can readily understand how each element operates by combining the steps shown in FIG. 5 and the elements shown in FIG. 2, FIG. 3 and FIG. 4, and further description is omitted here for brevity.

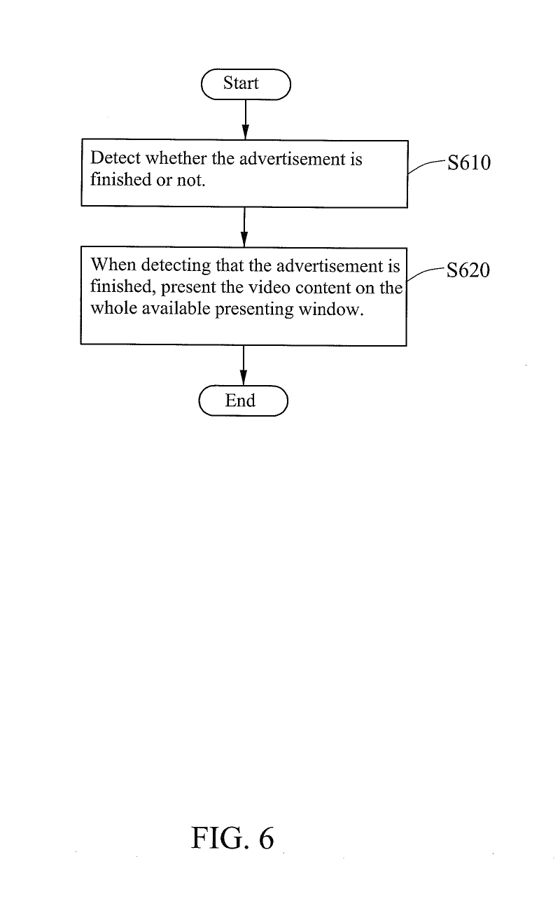

Please refer to FIG. 6. FIG. 6 is a flowchart illustrating a method for playing back advertisement and video content according to another exemplary embodiment of the present invention. As shown in FIG. 6, the method includes, but is not limited to, the following steps:

Step S610: Detect whether the advertisement is finished or not.

Step S620: When detecting that the advertisement is finished, present the video content on the whole available presenting window.

Furthermore, the following cases show some typical scenarios suitable for triggering the advertisement presenting method of the present invention.

(1) When a user prepares to start playing back a video content on an electronic apparatus, one or more advertisement usually pops out at this time.

(2) When a video content is paused by a user, one or more advertisement usually pops out at this time.

(3) When a user is seeking a video content quickly and the desired part of the video content is found, one or more advertisement can pop out at this time.

(4) Under some video content scenarios, advertisement suppliers can pop out advertisements related to the video content.

(5) When the playing back of a video content is finished, one or more advertisement can pop out at this time.

In all abovementioned scenarios, the present invention can be applied for simultaneously presenting the advertisement(s) and the real video content on the same available presenting window, which can give better user experience to the user.

The abovementioned embodiments are presented merely to illustrate practicable designs of the present invention, and should be considered to be limitations of the scope of the present invention. In summary, a method for simultaneously playing back advertisement and video content and an electronic apparatus to implement the method are provided in the present invention. By adopting the method for simultaneously playing back advertisement and video content and the electronic apparatus of the present invention, an available presenting window of an electronic apparatus can be split into a primary presenting part for presenting a video content and at least one secondary presenting part for presenting one or more advertisement. Therefore, the video content and the advertisement can be presented on the available presenting window of the electronic apparatus simultaneously. A user can watch the real video content that he/she is interested immediately and no need to waste time on waiting until the advertisement is finished, which bring more convenience to the user.

Those skilled in the art will readily observe that numerous modifications and alterations of the device and method may be made while retaining the teachings of the present invention.

What is claimed is:

1. A method for playing back advertisement and video content, applied to an electronic apparatus, comprising:
detecting whether an advertisement need to be played back or not;
when detecting that the advertisement needs to be played back, splitting an available presenting window of the electronic apparatus into a primary presenting part and at least one secondary presenting part according to a split policy;
presenting a video content on the primary presenting part of the available presenting window; and
presenting the advertisement on the at least one secondary presenting part of the available presenting window;
wherein the video content and the advertisement are presented on the available presenting window of the electronic apparatus simultaneously.

2. The method as claimed in claim 1, further comprising:
detecting whether the advertisement is finished or not; and
when detecting that the advertisement is finished, presenting the video content on the whole available presenting window.

3. The method as claimed in claim 1, further comprising:
detecting whether the video content is started or not; and
when detecting that the video content starts to be played back, detecting whether the advertisement need to be played back or not.

4. The method as claimed in claim 1, further comprising:
detecting whether the video content is paused or not; and
when detecting that the video content is paused, detecting whether the advertisement need to be played back or not.

5. The method as claimed in claim 1, further comprising:
detecting whether the electronic apparatus is seeking the video content or not; and
when detecting that the electronic apparatus is seeking the video content, detecting whether the advertisement need to be played back or not.

6. The method as claimed in claim 1, further comprising:
detecting whether a playback status of the video content is suitable for playing back the advertisement; and
when detecting that the playback status of the video content is suitable for playing back the advertisement, detecting whether the advertisement need to be played back or not.

7. The method as claimed in claim 1, further comprising:
detecting whether the video content is finished or not; and
when detecting that the video content is finished, detecting whether the advertisement need to be played back or not.

8. The method as claimed in claim 1, wherein a sum of a size of the primary presenting part and a size of the secondary presenting part is smaller than or equal to a size of the available presenting window.

9. An electronic apparatus for playing back advertisement and video content, comprising:
a detecting unit, configured for detecting whether an advertisement need to be played back or not;
a splitting unit, coupled to the detecting unit, configured for splitting an available presenting window of the electronic apparatus into a primary presenting part and at least one secondary presenting part according to a split policy when the detecting unit detects that the advertisement needs to be played back; and
a display screen, coupled to the splitting unit, configured for presenting a video content on the primary presenting part of the available presenting window, and presenting the advertisement on the at least one secondary presenting part of the available presenting window;
wherein the video content and the advertisement are presented on the available presenting window of the display screen of the electronic apparatus simultaneously.

10. The electronic apparatus as claimed in claim 9, wherein:
the detecting unit is further configured for detecting whether the advertisement is finished or not; and
the display screen is further configured for presenting the video content on the whole available presenting window when the detecting unit detects that the advertisement is finished.

11. The electronic apparatus as claimed in claim 9, wherein:
the detecting unit is further configured for detecting whether the video content start to be played back or not; and
the detecting unit is further configured for detecting whether the advertisement need to be played back or not when it detects that the video content starts to be played back.

12. The electronic apparatus as claimed in claim 9, wherein:
the detecting unit is further configured for detecting whether the video content is paused or not; and
the detecting unit is further configured for detecting whether the advertisement need to be played back or not when it detects that the video content is paused.

13. The electronic apparatus as claimed in claim 9, wherein:
the detecting unit is further configured for detecting whether the electronic apparatus is seeking the video content or not; and
the detecting unit is further configured for detecting whether the advertisement need to be played back or not when it detects that the electronic apparatus is seeking the video content.

14. The electronic apparatus as claimed in claim 9, wherein:
the detecting unit is further configured for detecting whether a playback status of the video content is suitable for playing back the advertisement; and
the detecting unit is further configured for detecting whether the advertisement need to be played back or not when it detects that the playback status of the video content is suitable for playing back the advertisement.

15. The electronic apparatus as claimed in claim 9, wherein:
the detecting unit is further configured for detecting whether the video content is finished or not; and
the detecting unit is further configured for detecting whether the advertisement need to be played back or not when it detects that the video content is finished.

16. The electronic apparatus as claimed in claim 9, wherein a sum of a size of the primary presenting part and a size of the secondary presenting part is smaller than or equal to a size of the available presenting window.
